(19) United States
(12) Patent Application Publication
(10) Pub. No.: US 2015/0339392 A1
(43) Pub. Date: Nov. 26, 2015

(54) MULTI-QUERY SEARCH SYSTEM AND METHOD

(71) Applicants: Randy Reineck, Pahrump, NV (US); Gregory Ross, Pahrump, NV (US)

(72) Inventors: Randy Reineck, Pahrump, NV (US); Gregory Ross, Pahrump, NV (US)

(21) Appl. No.: 14/701,385

(22) Filed: Apr. 30, 2015

Related U.S. Application Data
(60) Provisional application No. 62/002,776, filed on May 23, 2014.

(51) Int. Cl. G06F 17/30

(52) U.S. Cl. CPC G06F 17/30867

(57) ABSTRACT

A multi-query search system receives distinct queries for execution on one or more data sources to retrieve relevant search results for a line of inquiry. Individual search results are accumulated and stored based on user selection regardless of the query or data source from which they arose. The accumulated search results may be shared with other users to permit collaboration with regard to modifying or improving the accumulated search results and making decisions based on the accumulated search results.

### CROSS-REFERENCE TO RELATED APPLICATION

This application claims priority to U.S. Provisional Patent Application No. 62/002,776, filed May 23, 2014.

### BACKGROUND OF THE INVENTION

1. Field of the Invention

The invention relates to information processing and search and in particular to a multi-query search system and method that generates and accumulates search results for one or more users.

2. Related Art

Traditional search systems, such as web-based search engines, receive a search query and return relevant results as determined by their respective ranking or rating methodologies. A user may then peruse these results and select the search result they desire according to their assessment of each of the results.

If none of the search results meet the user's needs, another search query may be issued, and in response, these search engines would accordingly return another set of results based on their respective ranking or rating methodologies. The user can repeat this process as desired or as needed.

From the discussion that follows, it will become apparent that the present invention addresses the deficiencies associated with the prior art while providing numerous additional advantages and benefits not contemplated or possible with prior art constructions.

### SUMMARY OF THE INVENTION

A multi-query search system is disclosed herein. As will be detailed further below, the multi-query search system generates search results that are cumulative rather than discarded across distinct queries and data sources. This is beneficial in that a user may initiate a line of inquiry to accumulate search results that are desired or needed by the user. The multi-query search system supports multiple distinct data sources upon which the queries in a line of inquiry may be executed. In addition, accumulated search results may themselves be searched and may be shared with other users to allow collaboration, such as to modify or improve accumulated search results. The accumulated search results may then be used to make a decision by the user, one or more other users or both.

Various systems and methods relating to the multi-query search system are disclosed herein. For example, in one embodiment a multi-query search system is disclosed, with such system comprising one or more search servers comprising one or more storage devices and one or more communication devices, a plurality of client devices comprising one or more input devices and one or more display devices, and one or more storage devices. The communication devices are connected to one or more data sources, and the first queries and one or more second queries are received via the input devices.

The search servers receive the first queries and the second queries from the plurality of client devices, transmit the first queries and the second queries to the data sources via the communication devices, and receive one or more first search results and one or more second search results from the data sources respectively in response to the first queries and the second queries.

The search servers also receive a first selection from one or more of the plurality of client devices, the first selection comprising a subset of the first search results, receive a second selection from one or more of the plurality of client devices, the second selection comprising a subset of the second search results, and store the first selection and the second selection as accumulated search results on the storage devices. The accumulated search results are presented via the display devices of the plurality of client devices.

The plurality of first search results may be generated by a first data source and the plurality of second search results are generated by a second data source. Also, the communication devices may provide public access to the accumulated search results by transmitting the accumulated search results to one or more third party users. A rating for one or more entries in the accumulated search results may be received via the input devices. In such case, one or more entries in the accumulated search results may be removed therefrom if their ratings are below a particular threshold.

The accumulated search results may be stored in association with the first queries and the second queries on the storage devices. The plurality of client devices may query the first queries and the second queries stored on the storage devices.

In another exemplary embodiment, a multi-query search system comprises one or more communication devices configured to receive a plurality of first search results and a plurality of second search results from one or more data sources, one or more storage devices, and one or more processors.

The processors receive a first selection from one or more of a plurality of users, the first selection comprising a subset of the plurality of first search results, receive a second selection from one or more of the plurality of users, the second selection comprising a subset of the plurality of second search results, store the second selection in association with the first selection as accumulated search results on the storage devices, and transmit the accumulated search results to one or more of the plurality of users via the communication devices. The plurality of first search results and the plurality of second search results are generated based on at least two distinct queries.

The plurality of first search results may be generated by a first data source and the plurality of second search results are generated by a second data source. The communication devices may receive ratings of one or more entries of the accumulated search results from one or more of the plurality of users. In such case, one or more entries in the accumulated search results may be removed therefrom by the processors if their ratings are below a particular threshold. Also, entries in the accumulated search results may be sorted by the processors based on their ratings.

The communication devices may provide public access to the accumulated search results by transmitting the accumulated search results to one or more third party users. It is noted that the accumulated search results may be stored in association with at least two distinct queries.

In another exemplary embodiment a method for locating information with a multi-query search system is disclosed, with such method comprising, receiving a first query at one or more client devices, receiving first search results from the first query from one or more data sources via one or more communication devices, and receiving a first selection at the client devices, the first selection comprising a subset of the first search results.

The method also comprises receiving a second query at the client devices, receiving second search results from the second query from the data sources via the communication devices, receiving a second selection at the client devices, the second selection comprising a subset of the second search results, and transmitting the accumulated search results to the client devices for presentation via a display device of the client devices.

The first selection and the second selection may be stored on one or more storage devices as accumulated search results. The plurality of first search results may be generated by a first data source and the plurality of second search results are generated by a second data source. A rating for one or more entries may be stored in the accumulated search results. If so, one or more entries in the accumulated search results having a rating below a particular threshold may be removed. Public access to the accumulated search results may be provided by transmitting the accumulated search results from one or more other client devices.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary environment of use for a multi-query search system;

FIG. 2 is a flow diagram illustrating operation of an exemplary multi-query search system;

FIG. 3 is a block diagram illustration an exemplary user interface of a multi-query search system;

FIG. 4 is a block diagram illustrating an exemplary multi-query search system; and

FIG. 5 is a flow diagram illustrating an exemplary use case for a multi-query search system.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The multi-query search system herein improves upon traditional search engines/systems by allowing results from multiple queries to be accumulated rather than discarded. In a traditional search system, search results retrieved for a first query are discarded and replaced by search results retrieved for any subsequent query. Though results may be refined, such as by specifying additional search criteria, a user of a traditional search system is limited to the result set from the user's original query.

As will be detailed further below, the multi-query search system herein is capable of processing multiple distinct queries, and accumulating (and thus preserving) search results from each distinct query. As such, a user may issue multiple distinct queries to find a desired search result or desired set of search results, and accumulate useful search results from each distinct query via the multi-query search system. It is noted that the user queries supported by the multi-query search system can indeed be quite distinct from one another, even in the subject matter sought by each query. The multi-query search system allows the user to accumulate the user's search results in any case. This allows the user's search scope to be defined by the user.

The multi-query search system is also capable of providing a collaborative or social search environment to a community of users that wish to search and/or review search results collaboratively. The plurality of unique perspectives and experience from the user community can advantageously be used in this manner to find, accumulate, and review search results.

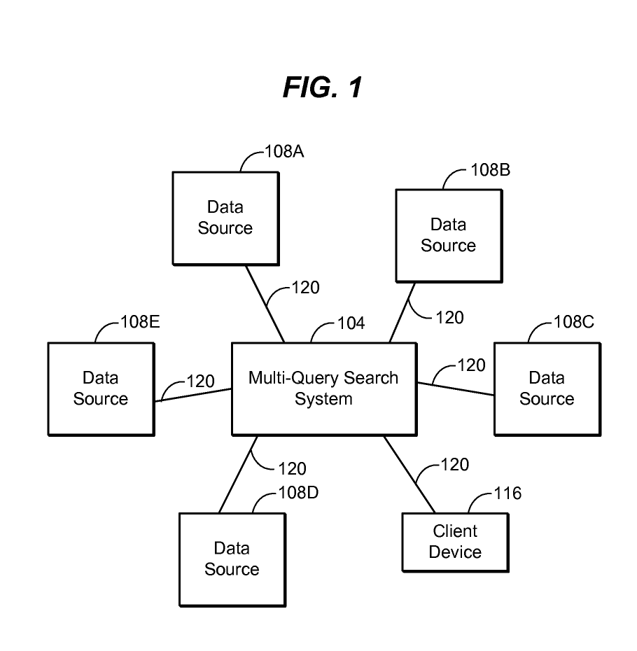

The multi-query search system will now be described with regard to FIG. 1. FIG. 1 is a block diagram illustrating the multi-query search system 104 and an exemplary environment of use for the same. As can be seen, the multi-query search system 104 may communicate with one or more data sources 108. Though shown as external to or separate from the multi-query search system 104, it is contemplated that one or more data sources 108 may be internal to or integrated in the multi-query search system in some embodiments.

A data source 108 will typically provide response data in response to a request from the multi-query search system 104. Each data source 108 may store and provide data relating to one or multiple fields of inquiry. In addition, each data source may store data in various formats, including structured and unstructured data formats. A data source 108 may be operated by an independent third party operator from that of the multi-query search system 104 as well. Some exemplary third party data sources 108 include social networks, online retailers, and e-commerce databases, websites or other online resources that the multi-query search system 104 can access.

The multi-query search system 104 may transmit one or more requests to one or more data sources 108 and receive response data via one or more communication links 120. A communication link 120 may be a wired or wireless link and utilize various communication protocols shared by the multi-query search system 104 and a data source 108. One or more communication links 120, such as in a network configuration or topology, may link a multi-query search system 104 to one or more data sources 108. The request from a multi-query search system 104 will be formatted, such as according to an API, protocol, or other specification of a data source 108, so that the request can be properly interpreted by the data source. Likewise, response data from the data source 108 will be formatted such that it can be properly interpreted upon receipt by the multi-query search system 104.

The multi-query search system 104 will typically generate a request to the one or more data sources 108 based on input received at one or more client devices 116. For example, the multi-query search system 104 may translate or reformat the input from a first format to one or more second formats that can be properly interpreted by one or more data sources 108 for which it is intended (or all available data sources). Typically such input will be in the form of a search query from the user. As can be seen a client device 116 may communicate with the multi-query search system 104 via one or more communication links 120 and shared communication protocols, such as described above. It is noted that a client device 116 may be configured to translate or reformat a user's search query from a first format to one or more second formats such that the search query may be properly interpreted by the multi-query search system 104 and/or one or more data sources 108.

A client device 116 will typically provide an interface through which a user can access/use the multi-query search system 104. Some exemplary client devices 116 include tablets, smartphones, laptop computers, desktop computers, media players, and game consoles. Other portable or non-portable computing devices configured to communicate with the multi-query search system 104, such as through a web browser or other locally (or remotely) stored client software application, may also be used. In one or more embodiments, a client device 116 will comprise one or more input devices, such as a keyboard, mouse, touchscreen, microphone, camera, or various combinations thereof, as well as one or more output devices, such as a display (touch-enabled or not) or other visual readout or indicator. A user interface to allow a user to use and interact with the multi-query search system 104 may be presented via an output device and used or interacted with via one or more input devices.

As alluded to above, each of the data sources 108, client devices 116 and the multi-query search system 104 may comprise one or more communication devices to provide one or more communication links 120 through which these elements communicate. A communication device may be configured to communicate wirelessly or through a wired connection and through various communication protocols. It is noted that a communication device may negotiate with another communication device in order to establish a usable communication link 120.

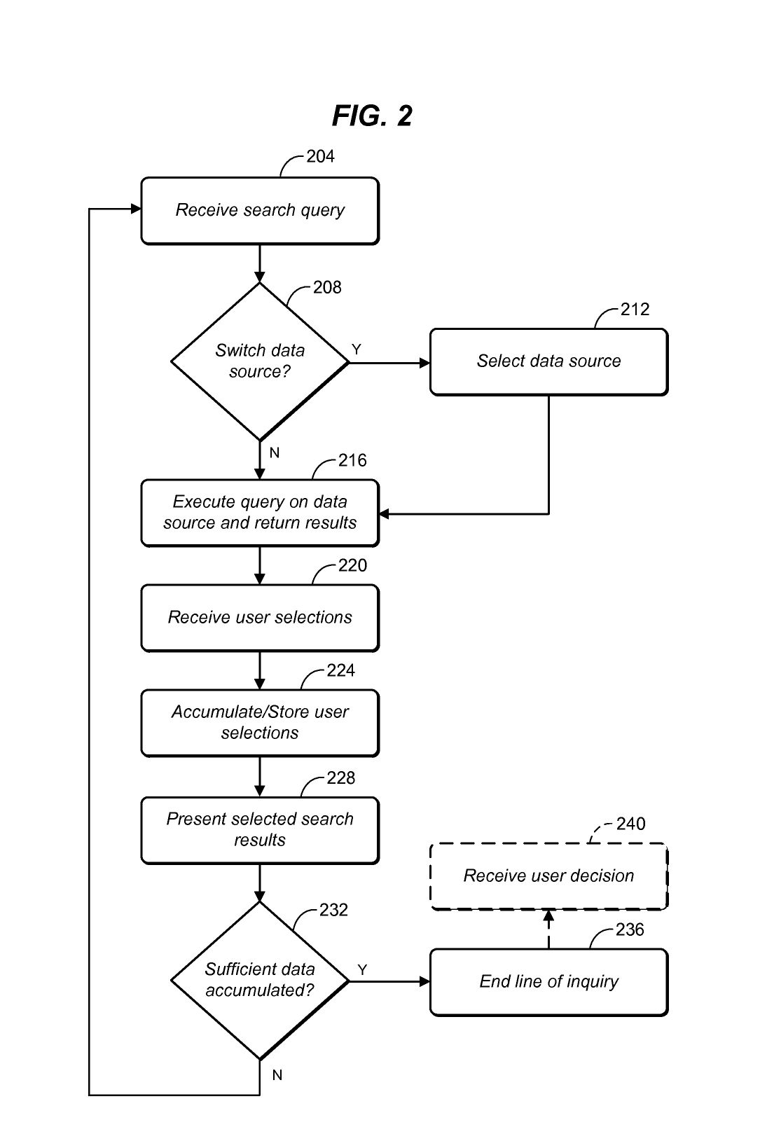

The multi-query search system 104 will now be described with regard to FIG. 2. FIG. 2 is a flow diagram illustrating operation of an exemplary multi-query search system 104 as well as its accumulation capability. Though presented in a particular sequence, it will be understood by one of ordinary skill in the art that some of the following steps may occur in a different order. At a step 204, a search query is received at the multi-query search system. As described above, the search query may be inputted by a user at a client device and subsequently transmitted from the client device for receipt at the multi-query search system.

At a decision step 208, the multi-query search system determines a data source to execute the query upon. This determination may occur in various ways. In one exemplary embodiment, the multi-query search system may switch data sources if the user explicitly specifies a different data source for the user's query. To illustrate, the user may be prompted to select a data source at a decision step 208, and then select a particular data source at a step 212, such as a particular online retailer or search engine, via the user's client device. It is noted that the user may select multiple data sources as well and, in such case, the query would be executed on each of the selected data sources.

In another exemplary embodiment, the multi-query search system may automatically select a data source based on the user's query at step 212. For example, if a query matches a predefined pattern, regular expression or other heuristic the multi-query search system may automatically execute the query on an associated data source. To illustrate, a query including an address may be executed on one or more data sources that provide mapping or place information, such as an online map or rating/review service. Similarly, in some embodiments, if the query includes one or more particular keywords, the query may be executed on a data source associated with the keyword or subject matter of the keyword. To illustrate, a query including one or more terms describing clothing may be executed on one or more data sources of online clothing retailers.

It is contemplated that data sources may also be switched in round robin or other sequential fashion, or randomly switched and selected in some embodiments such as through a random number generator. As alluded to above, the selection of a data source 212 causes the query to be transmitted from the multi-query search system to that data source. The query can then be executed or run on the data source at a step 216.

Execution of a query at step 216 may occur in various ways. In some embodiments, the query is transmitted from the multi-query search system to the data source, and the data source interprets the query to locate search results on one or more of its data storage devices. The search results are then provided to the user, such as by transmitting the results to the multi-query search system and the through to the user's client device 116. Alternatively, if the data source is a data storage device directly accessible by the multi-query search system, such as a local or remote hard drive, the multi-query search system may locate search results by directly searching the data storage device. Thereafter, the search results may be provided to the user, such as by transmitting the results to the user's client device.

As described above, the search results may arrive in different formats. To illustrate, a first data source may provide search results in HTML format, while a second data source may provide search results as raw data, such as in JSON, XML, or other text or binary data formats.

At a step 220, user selections of one or more particular search results may be received by the multi-query search system. To illustrate, the user may select individual search results via the user's client device, which subsequently transmits such selections to the multi-query search system. It is contemplated that a user will typically select the one or more search results that the user deems is relevant, useful or worthwhile to the user. In some embodiments, the multi-query search system may be configured to automatically select one or more search results if they meet predefined criteria for the user. For example, search results that match the user's query with a degree of confidence over a predefined threshold may be automatically selected for the user. As another example, only search results that are an exact match for the user's query may be automatically selected. To illustrate, a search result matching user query for a particular product by model number may be automatically selected if the search result precisely matches the queried model number.

The one or more selected search results are accumulated at a step 224. Typically, this causes the selected search results to be stored on a data storage device accessible to the multi-query search system. A search result may be stored in various ways. For instance, a search result may be stored by storing its URL or other link, its contents, and/or a subset of its contents. In the case of a subset, an image or selection of text or other information from a search result may be stored.

At step 224, if there are any previously selected search results, any new selections of search results received at step 220 would be accumulated thereto, thereby enlarging the set of search results. At a step 228, the accumulation of selected search results are presented together to the user, such as by transmitting the accumulation of selected search results from the multi-query search system to the user's client device for display/presentation thereon. In this manner, search results from distinct queries as well as distinct data sources can be both accumulated and presented to a user.

At a decision step 232, the multi-query search system may determine whether sufficient data (i.e., search results) have been accumulated. This determination may occur in various ways. Typically, a user will indicate whether sufficient data has been accumulated such as by forgoing additional queries. Alternatively or in addition, a user may indicate to the multi-query search system that the current line of inquiry has been completed, such as via the user's client device. To illustrate, the user may engage an “End Query” button or the like to indicate to the multi-query search system that this line of inquiry is complete.

The user may indicate that there is insufficient data by inputting another query for receipt by the multi-query search system at step 204. As shown in FIG. 2, the process may then be repeated to allow the user to accumulate additional search results.

If sufficient data has been accumulated at decision step 232, the line of inquiry may be ended at a step 236. This may occur by taking no action at all once the user ceases interaction with the multi-query search system. Alternatively, some action may be taken at step 236 when a search session ends. For example, the accumulation of selected search results may be stored together for later retrieval, modification, deletion or other use by the user or other users. It is noted that a stored accumulation of selected search results may be associated with the user's account or multiple user accounts (previously established on the multi-query search system) to provide access control to the stored accumulation based on authorized user credentials. Alternatively or in addition, the store accumulation may be associated with a URL, link or other identifier for subsequent access.

At an optional step 240, the multi-query search system may receive one or more user decisions. For instance, the user may indicate one or more of the most relevant search result in the accumulation of search results. These search results may then be highlighted or otherwise made more prominent, such as by displaying them before other search results. User decisions may be received from multiple users. For instance, one or more users may indicate their own preference for the one or more most relevant search results. Thereafter, the most relevant search results as determined by a community of users can be highlighted or otherwise made more prominent.

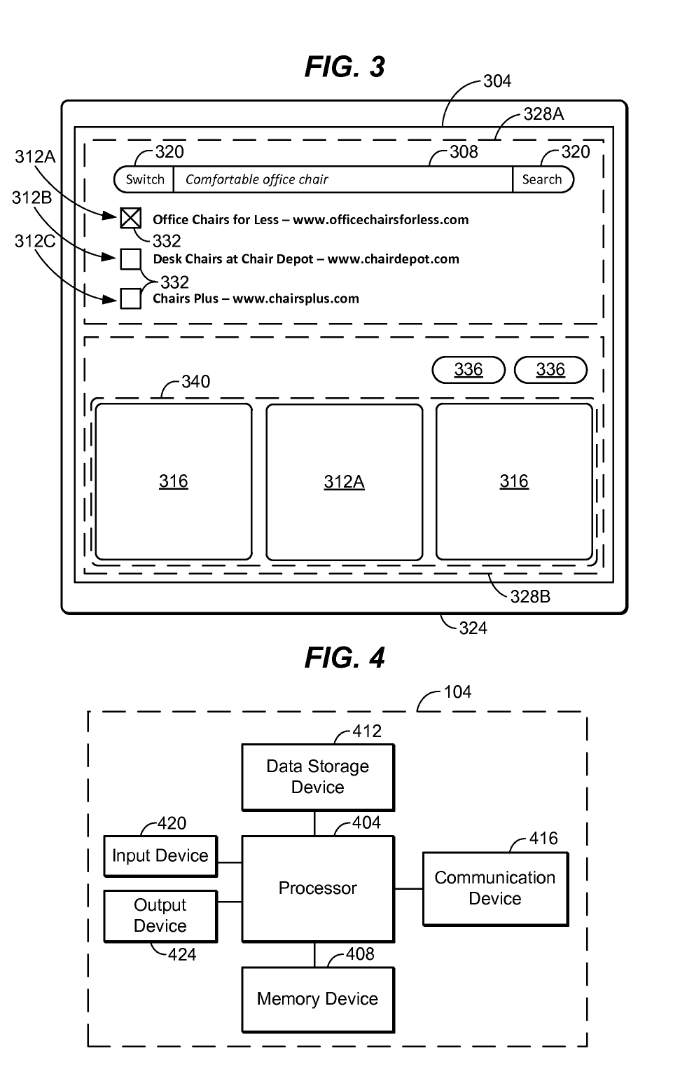

FIG. 3 illustrates a user interface 304 of an exemplary multi-query search system. As can be seen, the user interface may comprise separate sections 328 or portions and may be presented via a display screen 324. Though illustrated on a single page or window it is noted that the sections 328 may be on separate pages or windows, and in such case may be accessed via a navigation control, such as a button, link or the like.

As shown, the user interface 304 comprises a search section 328A and an accumulated search results section 328B. The search section 328A will typically be configured to receive a user's query, such as via an input box 304 where text or other input may be inputted. One or more buttons 320 may be provided to, when engaged by a user, execute an inputted query and/or switch data sources, such as described above. Though shown as separate sections it is noted that the elements of the search section 328A and results section 328B may be commingled in one area or section in some embodiments.

One or more search results 312 may be presented in the search section 328A as well. As shown in FIG. 3 for example, a plurality of search results 312 are displayed as a result of a query. As described above, the user may accumulate one or more of the search results 312 by selecting them. In one or more embodiments, the user may do so by engaging a portion of the desired search result 312, such as a button 332 or other control associated with each search result 312.

Once selected, a search result 312 may be appear in the accumulated search results section 328B. As illustrated in FIG. 3 for example, the selected search result 312A from the current query appears in the accumulated search results section 328B along with previously selected search results 316. A variety of search results from various data sources and various queries can thus be accumulated using the multi-query search system in this manner. As can be seen, the user retains the search results that are desired across multiple distinct queries at one or more data sources. This is advantageous in that it allows the user to curate the user's own accumulation of relevant search results for the user's particular line of inquiry.

One or more buttons 336 may be provided in the accumulated search results section 328B to initiate sharing of accumulated search results 340 with other users. These others users may be presented the accumulated search results 340 in an accumulated search results section 328B. It is noted that the accumulated search results 340 may be presented in various ways. As shown in FIG. 3 for example, the accumulated search results 340 are presented as tiles, which may comprise one or more images, text, or a combination thereof. Some other exemplary presentation formats include, lists and tables. Each search result 312, 316 in the accumulated search results 340 may be presented in a grouping with other search results from the same query. Alternatively, the accumulated search results 340 may be commingled with one another regardless of the query that generated them. In addition, a button 336 may be engaged to cause the accumulated search results 340 to be saved by the multi-query search system.

It is contemplated that one or more users may interact with the accumulated search results 340 such as by engaging a button, link, control, or predefined portion of any of the search results. A different function may be performed depending on the type of user engagement. For example, clicking a link may navigate the user to a webpage defined by the search result's URL or present further detail about the search result. As another example, clicking a button associated with one of the accumulated search results 340 may allow a user to rate or comment on the search result. This allows a community of users to collaborate on the accumulated search results. For example, when choosing a product, the highest rated search result may represent the product a community wishes to purchase for themselves.

Components of an exemplary multi-query search system 104 will now be described with regard to FIG. 4. It is contemplated that the multi-query search system 104 may be implemented in one or more servers, network appliances, computing devices, or the like. FIG. 4 illustrates a multi-query search system as a server or other computing device.

As can be seen, the multi-query search system 104 may comprise one or more processors 404 and memory devices 408, and utilize one or more data storage devices 412. A processor 404 may be configured to control the operation of the multi-query search system 104 to provide the functionality disclosed herein. The processor 404 may be hardwired with instructions for providing this functionality or may execute instructions, such as machine readable code, retrieved from a data storage device 412. It is contemplated that the memory devices 408 may be RAM or the like for temporary storage use. Non-transitory or more permanent data storage may be provided by a data storage devices 412, which may utilize various storage technologies, such as magnetic, optical, or flash based storage. A multi-query search system 104 may also include one or more input devices 420, such as a keyboard, mouse, touchscreen, microphone, camera, or various combinations thereof, and output devices 424, such as a display screen, speaker, or other readout, that an administrator or other operator may use to use, control, or otherwise interact with the multi-query search system 104.

One or more communication devices 416 to permit communication with external devices, such as remote data storage devices 412, data sources, client devices are included as well. As discussed above, a communication device 416 may support various wired or wireless communication links and communication protocols, and is used to communicate requests and response data thereto as well as queries and search results thereof, along with other data.

In operation, a data storage device 412 may be used to store selected/accumulated search results. In addition, various user identifiers may be stored on a data storage device 412 such as to identify an association between a particular user and the user's accumulated search results. This functionality may be used to provide access control to the user's accumulated search results such as by requiring a valid username and password or other credentials before access may be granted. In addition, this functionality can be used to notify a user when another user interacts with (e.g., comments or rates) one of the user's accumulated search results.

A processor 404 may also be configured to generate a user interface, such as the user interface described with regard to FIG. 3. To illustrate, a processor 404 may generate HTML, CSS, or other instructions or machine readable code to present a visual or other output representation of a user interface (including search results and/or accumulated search results) on a client device.

Though described above as implemented in a server or server appliance-type computing device, it is contemplated that the multi-query search system may have other implementations as well. For instance, the multi-query search system may be implemented in stored software, hardware or a combination thereof on client device.

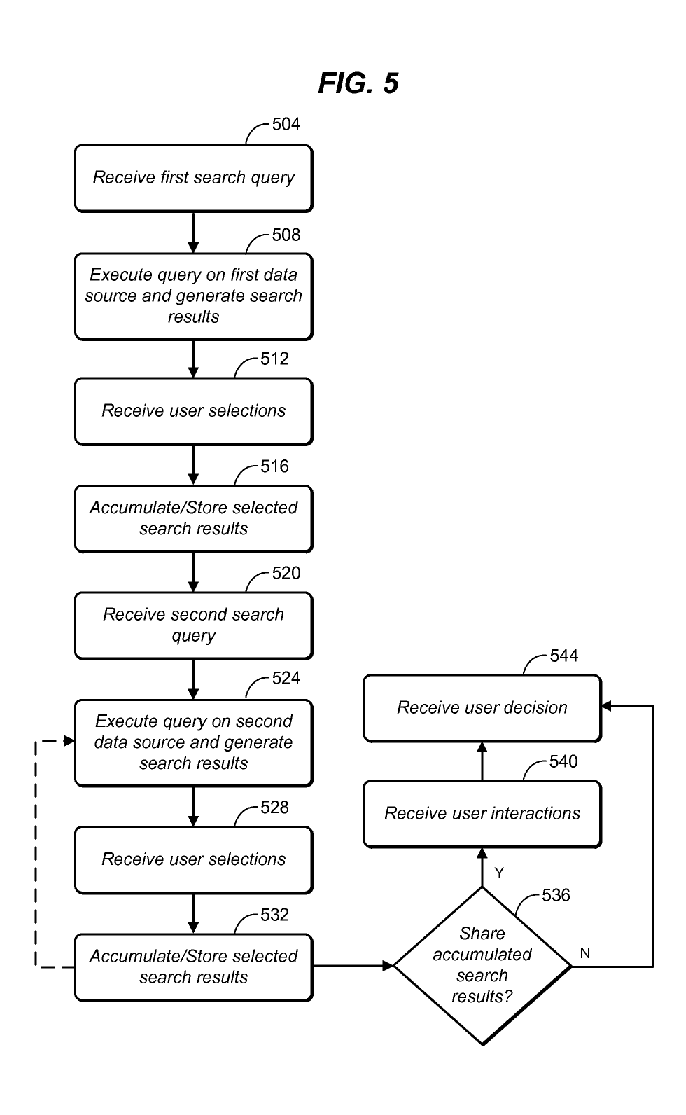

An exemplary use case will now be described with regard to the flow diagram of FIG. 5 and with reference to FIG. 1. As will become apparent from the following, the user in this use case is shopping and utilizing the multi-query search system 104 via a client device 116 to conduct the search as well as to make a purchasing decision. Though described with regard to purchasing goods, it will be understood that the multi-query search system 104 may be used in researching various other subject matter.

At a step 504, multi-query search system 104 receives a first query for a first data source 108A from the user via the user's client device 116. In this example, the first data source 108A is an online retail site offering new goods. The first query is then executed on the first data source 108A and search results are accordingly generated based on the queries at a step 508. At a step 512, the user's selection of one or more of the search results as desired are received by the multi-query search system 104. The user may peruse the search results, such as by following any URLs or other links, to decide which of the search results to select. The selected search results are stored at a step 516. If any prior selected search results exist, the newly selected search results are added thereto, such as described above.

At a step 520, the multi-query search system 104 receives a second query. The second query may be the same or distinct from the first query. At a step 524, the second query is executed on the second data source 108B resulting in search results that the user may peruse and select. At a step 528, the user's selection of one or more search results are received by the multi-query search system 104, and are accumulated and stored at a step 532 in association with the previously selected search results from the first query. The combined selected search results, in combination, form the accumulated search results.

If the accumulated search results are insufficient, the user may optionally conduct one or more additional queries on the second data source 108B or another data source 108C-108E, as illustrated by the dashed arrow from step 532 to step 524. Any resulting search results may then be added to the accumulated search results as described above. As can be seen, the user may continue switching and querying different data sources as desired or as necessary in this manner.

If the accumulated search results are sufficient, the accumulated search results may be shared with one or more other users. At a decision step 536, if the user engages the sharing process one or more other users would receive and then be permitted at least to view and optionally to interact with the accumulated search results. At a step 540, any such interactions from these other users, such as comments or ratings, may be received by the multi-query search system 104 (via these users' client devices).

These interactions may assist the user in making a purchasing decision because each user can collaborate with the other users via comments, ratings or other communication for each accumulated search result. It is contemplated that each of the users may also be permitted to add search results to the accumulated search results by conducting their own queries on one or more data sources. In addition, each of the users may be permitted to remove or request removal of one or more of the accumulated search results. In this manner, a user or users can generate a working list of possible products for purchase. In addition, since the accumulated search results are interactive, a user can engage the search results to retrieve their contents/details and make comparisons therebetween in making a purchasing decision.

At a step 544, the user may make a purchasing (or other) decision based on the accumulated search results and/or interaction with other users. It is contemplated that the purchase may be executed by engaging the accumulated search result associated with the product the user has decided to purchase. In this example, if the user decides to purchase a new product, the multi-query search system 104 would navigate the user to an online store associated with the first data source 108A, while purchase of a used product would occur at the online store associated with the second data source 108B.

It is noted that accumulated search results may also be made publicly available, rather than explicitly shared with one or more particular users. To illustrate, in one or more embodiments, a user may be permitted to search through accumulated search results previously generated on the multi-query search system. This allows this user to benefit from research across multiple data sources that has already been conducted previously either by the user him or herself or by another user (or users). In addition, this also allows this user or a group of users to continue or complete a line of inquiry started by one or more other users.

In operation, the multi-query search system may store each of the queries issued to generate a particular set of accumulated search results. Thereafter, a search of accumulated search results may then be conducted through these stored queries, such as by a keyword or other search through the queries themselves. Any similar or matching queries and associated accumulated search results may then be presented to the user for review, interaction or other use. It is contemplated that the user may elect to create a copy of an existing set of accumulated search results so that the user may add, remove, or otherwise interact with the search results therein without disturbing the original accumulated search results.

As can be seen from the above, accumulated search results may be generated and shared in various ways in a collaborative environment comprising multiple users. It is contemplated that a group of users may engage together in a line of inquiry via the multi-query search system to generate accumulated search results that address the line of inquiry. In addition, individual or subgroups of such group of users may explore different branches (i.e., related searches) related to or within the line of inquiry, with their search results being accumulated for review and use by the entire group as a whole. Alternatively, it is noted that the subgroup's search results may first be accumulated for consideration by the subgroup. A subset of such search results can subsequently be added to accumulated search results for the group as a whole upon selection by the subgroup. In this manner, various subgroups of users can work separately to find information for the group as a whole while also having control over which search results are passed on (i.e., accumulated) to the group as a whole.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A multi-query search system comprising:
one or more search servers comprising one or more storage devices and one or more communication devices, wherein the one or more communication devices are connected to one or more data sources;
a plurality of client devices comprising one or more input devices and one or more display devices, wherein one or more first queries and one or more second queries are received via the one or more input devices; and
one or more storage devices;
wherein the one or more search servers:
receive the one or more first queries and the one or more second queries from the plurality of client devices;
transmit the one or more first queries and the one or more second queries to the one or more data sources via the one or more communication devices;
receive one or more first search results and one or more second search results from the one or more data sources respectively in response to the one or more first queries and the one or more second queries;
receive a first selection from one or more of the plurality of client devices, the first selection comprising a subset of the one or more first search results;
receive a second selection from one or more of the plurality of client devices, the second selection comprising a subset of the one or more second search results; and
store the first selection and the second selection as accumulated search results on the one or more storage devices;
wherein the accumulated search results are presented via the one or more display devices of the plurality of client devices.

2. The multi-query search system of claim 1, wherein the plurality of first search results are generated by a first data source and the plurality of second search results are generated by a second data source.

3. The multi-query search system of claim 1, wherein the one or more communication devices provide public access to the accumulated search results by transmitting the accumulated search results to one or more third party users.

4. The multi-query search system of claim 1, wherein the accumulated search results are stored in association with the one or more first queries and the one or more second queries on the one or more storage devices.

5. The multi-query search system of claim 4, wherein the plurality of client devices are arranged to query the one or more first queries and the one or more second queries stored on the one or more storage devices.

6. The multi-query search system of claim 1, wherein a rating for one or more entries in the accumulated search results is received via the one or more input devices.

7. The multi-query search system of claim 6, wherein one or more entries in the accumulated search results are removed therefrom if their ratings are below a particular threshold.

8. A multi-query search system comprising:
one or more communication devices configured to receive a plurality of first search results and a plurality of second search results from one or more data sources;
one or more storage devices; and
one or more processors that:
receive a first selection from one or more of a plurality of users, the first selection comprising a subset of the plurality of first search results;
receive a second selection from one or more of the plurality of users, the second selection comprising a subset of the plurality of second search results;
store the second selection in association with the first selection as accumulated search results on the one or more storage devices; and
transmit the accumulated search results to one or more of the plurality of users via the one or more communication devices;
wherein the plurality of first search results and the plurality of second search results are generated based on at least two distinct queries.

9. The multi-query search system of claim 8, wherein the plurality of first search results are generated by a first data source and the plurality of second search results are generated by a second data source.

10. The multi-query search system of claim 8, wherein the one or more communication devices receive ratings of one or more entries of the accumulated search results from one or more of the plurality of users.

11. The multi-query search system of claim 10, wherein one or more entries in the accumulated search results are removed therefrom by the one or more processors if their ratings are below a particular threshold.

12. The multi-query search system of claim 10, wherein entries in the accumulated search results are sorted by the one or more processors based on their ratings.

13. The multi-query search system of claim 8, wherein the one or more communication devices provide public access to the accumulated search results by transmitting the accumulated search results to one or more third party users.

14. The multi-query search system of claim 8, wherein the accumulated search results are stored in association with the at least two distinct queries.

15. A method for locating information with a multi-query search system comprising:
receiving a first query at one or more client devices;
receiving first search results from the first query from one or more data sources via one or more communication devices;
receiving a first selection at the one or more client devices, the first selection comprising a subset of the first search results;
receiving a second query at the one or more client devices;
receiving second search results from the second query from the one or more data sources via the one or more communication devices;
receiving a second selection at the one or more client devices, the second selection comprising a subset of the second search results; and
transmitting the accumulated search results to the one or more client devices for presentation via a display device of the one or more client devices.

16. The method of claim 15 further comprising storing the first selection and the second selection on one or more storage devices as accumulated search results.

17. The method of claim 15, wherein the plurality of first search results are generated by a first data source and the plurality of second search results are generated by a second data source.

18. The method of claim 15 further comprising receiving a rating for one or more entries in the accumulated search results.

19. The method of claim 18 further comprising removing one or more entries in the accumulated search results having a rating below a particular threshold.

20. The method of claim 15 further comprising providing public access to the accumulated search results by transmitting the accumulated search results from one or more other client devices.
